(19) United States
(12) Patent Application Publication
(10) Pub. No.: US 2009/0058731 A1
(43) Pub. Date: Mar. 5, 2009

(54) Dual Band Stacked Patch Antenna

(75) Inventors: Kevin Geary, Los Angeles, CA (US); James H. Schaffner, Chatsworth, CA (US); Hui-Pin Hsu, Northridge, CA (US); Joseph S. Colburn, Malibu, CA (US); Hyok J. Song, Camarillo, CA (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/847,372

(22) Filed: Aug. 30, 2007

(51) Int. Cl. H01Q 9/04

(52) U.S. Cl. 343/700 MS

(57) ABSTRACT

One or more of the embodiments of a dual band stacked patch antenna described herein employ an integrated arrangement of a global positioning system (GPS) antenna and a satellite digital audio radio service (SDARS) antenna. The dual band antenna receives right hand circularly polarized GPS signals in a first frequency band, left hand circularly polarized SDARS signals in a second frequency band, and vertical linear polarized SDARS signals in the second band. The dual band antenna includes a ground plane element, an upper radiating element (which is primarily utilized to receive SDARS signals), dielectric material between the ground plane element and the upper radiating element, and a lower radiating element (which is primarily utilized to receive GPS signals) surrounded by the dielectric material. The dual band antenna uses only one conductive signal feed to receive both GPS and SDARS signals.

### TECHNICAL FIELD

The subject matter described herein generally relates to patch antennas, and more particularly relates to an integrated dual band stacked patch antenna that is suitable for use with both global positioning system (GPS) signals and satellite digital audio radio service (SDARS) signals.

### BACKGROUND

The prior art is replete with radio frequency (RF) and microwave antenna designs, structures, and configurations. Such antennas are utilized in many different applications to wirelessly transmit and receive signals that convey information or data. For example, modern automobiles (and other vehicles) might utilize a number of antennas that receive signals throughout the RF spectrum. Indeed, a vehicle may include one or more of the following systems: an AM/FM radio; a satellite radio; a GPS based navigation system; and a mobile telecommunication system. Some vehicles may include antennas to receive SDARS signals and/or GPS signals. In this context, L1 GPS signals are used for commercial navigation and mapping systems. By definition, SDARS signals that originate from satellites are left hand circularly polarized (LHCP) signals in the frequency band of 2.320 GHz to 2.345 GHz, and L1 GPS signals that originate from satellites are right hand circularly polarized (RHCP) signals in the frequency band of 1.57442 GHz to 1.57642 GHz. Some satellite radio systems also utilize terrestrial repeaters that transmit SDARS signals with vertical linear polarization (VLP) in the frequency band of 2.320 GHz to 2.345 GHz. These repeaters are employed to improve terrestrial signal reception by transmitting the SDARS signals at low elevation angles.

The traditional approach for achieving both GPS and SDARS reception in a vehicle is to place two individual patch antennas on the roof of the vehicle, where one antenna is devoted to the GPS band and the other antenna is devoted to the SDARS band. The distinct GPS antenna is individually designed for enhanced gain of RHCP signals in the GPS band, while the separate and distinct SDARS antenna is individually designed for enhanced gain of LHCP signals (and terrestrial VLP signals) in the SDARS band. Unfortunately, undesirable coupling often occurs between the two antennas when they are placed close to one another, which is often the case in vehicle installations that strive to achieve a streamlined and clean appearance. Such coupling degrades the overall performance of each antenna, particularly the VLP terrestrial gain in the SDARS frequency band (in addition, typical standalone SDARS patch antennas do not provide adequate VLP gain for reliable quality of service).

Two types of integrated GPS/SDARS patch antennas are described in United States Patent Application Publication No. 2006/0097924 A1. A first design employs a single layer structure with both radiating elements residing on the same dielectric layer. This first design may not provide a desirable amount of VLP gain for terrestrial SDARS signals. A second design employs a stacked structure having two feeds—one for the GPS signals and one for the SDARS signals. In addition, this second design uses a shorting pin connected between one radiating element and the ground plane. This second design has the disadvantage of having a relatively complex configuration, and the further disadvantage of requiring two distinct feed elements, which increases the complexity and cost of final assembly onto a vehicle.

### BRIEF SUMMARY

A dual band patch antenna as described herein includes a stacked arrangement of two radiating elements separated by dielectric material. Both radiating elements share the same conductive feed, which may simplify the construction, reduces manufacturing cost, and reduces final assembly time. In one embodiment suitable for use in vehicular deployments, the dual band patch antenna can be configured and tuned to receive RHCP GPS signals simultaneously with LHCP SDARS signals. This particular dual band patch antenna is at the same time also configured and tuned to provide enhanced gain for terrestrial VLP SDARS signals.

The above and other features can be provided by an embodiment of a dual band patch antenna that includes: a first patch antenna arrangement configured to receive signals in a first frequency band; a second patch antenna arrangement coupled to, and stacked on, the first patch antenna arrangement, the second patch antenna arrangement being configured to receive signals in a second frequency band; and only one signal feed shared by both the first patch antenna arrangement and the second patch antenna arrangement.

The above and other features can also be provided by an embodiment of a dual band patch antenna that includes: a first antenna arrangement comprising a ground plane element, a first radiating element, and a first dielectric layer coupled between ground plane element and the first radiating element; a second antenna arrangement coupled to the first antenna arrangement, the second antenna arrangement comprising a second radiating element and a second dielectric layer coupled to the second radiating element, and the second antenna arrangement being coupled to the first antenna arrangement such that the first radiating element is located between the first dielectric layer and the second dielectric layer; and a signal feed shared by both the first antenna arrangement and the second antenna arrangement.

The above and other features can also be provided by an embodiment of a dual band patch antenna that includes: a ground plane element having a signal port formed therein; an upper radiating element; dielectric material between the ground plane element and the upper radiating element; a lower radiating element located within the dielectric material, the lower radiating element comprising an aperture formed therein; and only one signal feed for both the upper radiating element and the lower radiating element, the signal feed being connected to the upper radiating element, and the signal feed extending through the dielectric material, through the aperture without contacting the lower radiating element, and through the signal port without contacting the ground plane element. The lower radiating element, the dielectric material, and the ground plane element cooperate to receive signals in a first frequency band, while the upper radiating element, the dielectric material, and the ground plane element cooperate to receive signals in a second frequency band.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

One or more embodiments of the invention will hereinafter be described in conjunction with the following drawing figures, wherein like numerals denote like elements, and

FIG. 1 is a top view of an embodiment of a dual band patch antenna;

FIG. 2 is a cross sectional view of the dual band patch antenna, as viewed from line 2-2 of FIG. 1;

FIG. 3 is a perspective phantom view of the dual band patch antenna shown in FIG. 1;

FIG. 4 is a graph of return loss versus frequency for the dual band patch antenna shown in FIG. 1;

FIG. 5 is a diagram of LHCP and RHCP gain patterns for the dual band patch antenna shown in FIG. 1, for a single frequency within/near the L1 GPS frequency band;

FIG. 6 is a diagram of LHCP and RHCP gain patterns for the dual band patch antenna shown in FIG. 1, for a single frequency within/near the SDARS frequency band;

FIG. 7 is a diagram of LHCP gain patterns for the dual band patch antenna shown in FIG. 1 and for a standalone SDARS single patch antenna at a single frequency within/near the SDARS frequency band;

FIG. 8 is a diagram of VLP gain patterns for the dual band patch antenna shown in FIG. 1 and for a standalone SDARS single patch antenna at a single frequency within/near the SDARS frequency band;

FIG. 9 is a top view of another embodiment of a dual band patch antenna; and

FIG. 10 is a top view of yet another embodiment of a dual band patch antenna.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

For the sake of brevity, conventional techniques and aspects related to GPS systems, SDARS systems, RF/microwave antenna design, and RF/microwave signal propagation may not be described in detail herein. In addition, those skilled in the art will appreciate that embodiments of the dual band patch antennas described herein may be practiced in conjunction with any number of applications and installations at any set of two or more frequency bands, and that the vehicular deployment described herein is merely one suitable example.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically.

A dual band patch antenna configured in the manner described herein can be used to receive signals in a first frequency band and to receive signals in a second frequency band. In practice, the antenna has a reciprocal operating nature, and the same antenna structure may be used both in receive mode and in transmit mode. In certain embodiments, the first frequency band and the second frequency band are non-overlapping, i.e., there are no shared frequencies in the two bands. The reception of the different signals may occur simultaneously, concurrently, or at different times. Although an antenna as described herein can be suitably configured and tuned to receive signals in any two frequency bands (within practical and economical limits), the following non-limiting examples relate to a vehicular implementation that is intended to support the L1 GPS band and the SDARS band, where the L1 GPS band is normally utilized for navigation messages, coarse-acquisition data, and encrypted precision code. More specifically, the antenna embodiments described herein are suitably configured to receive right hand circularly polarized L1 GPS signals in the 1.57442 GHz to 1.57642 GHz frequency band, to receive left hand circularly polarized SDARS signals in the 2.320 GHz to 2.345 GHz frequency band, and to receive vertical linear polarized SDARS signals in the 2.320 GHz to 2.345 GHz frequency band. This allows the antenna embodiments to be used with common satellite radio and GPS-based onboard navigation systems.

Again, the dual band capability of the embodiments described herein is not limited to GPS and SDARS frequency bands. Generally, such antenna embodiments can be configured and tuned to support any two bands, thus providing a compact, low cost, high performance, single feed, stacked patch antenna, regardless of polarization or gain pattern dependence.

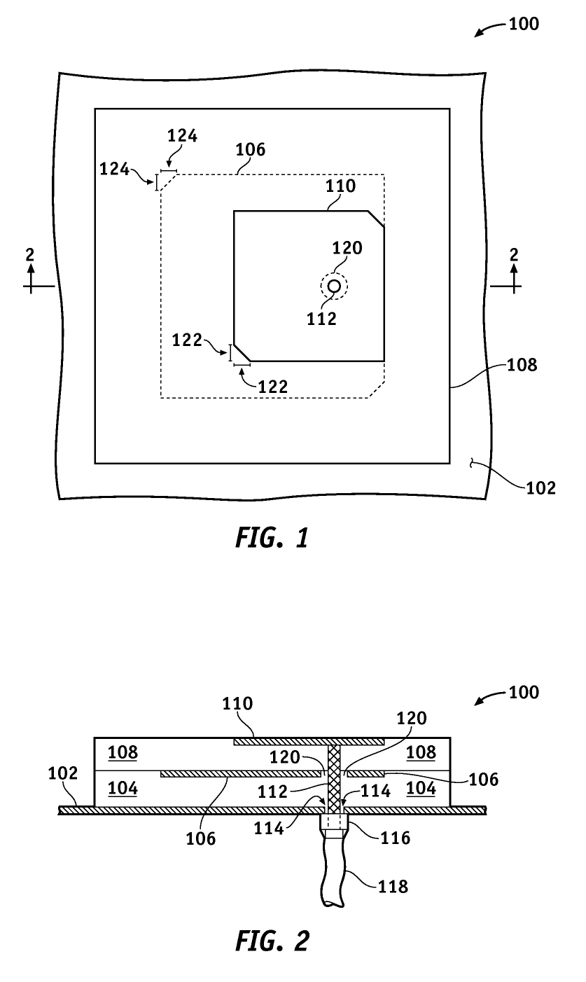

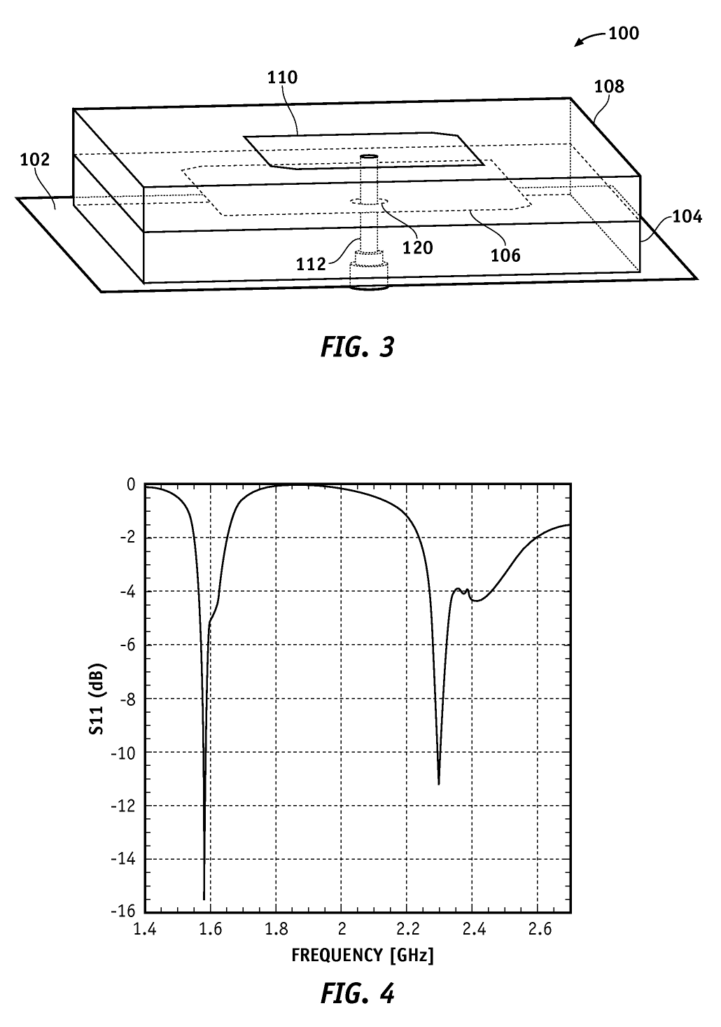

FIG. 1 is a top view of an embodiment of a dual band patch antenna 100, FIG. 2 is a cross sectional view of dual band patch antenna 100, as viewed from line 2-2 of FIG. 1, and FIG. 3 is a perspective phantom view of dual band patch antenna 100. Antenna 100 generally includes a first patch antenna arrangement configured to receive signals in a first frequency band (e.g., GPS signals), and a second patch antenna arrangement configured to receive signals in a second frequency band (e.g., SDARS signals), where the second patch antenna arrangement is coupled to and stacked on the first patch antenna arrangement. As described in more detail below, the first patch antenna arrangement can be formed as one separate component (for example, a first ceramic substrate with metallization areas, or a first printed circuit board with metallization areas) and the second patch antenna arrangement can be fabricated independently as another separate component (for example, a second ceramic substrate with metallization areas, or a second printed circuit board with metallization areas) and then attached to the first patch antenna arrangement.

In operation, the radiating element for the first (lower) patch antenna arrangement will have some effect on the performance of the second (upper) patch antenna arrangement and, analogously, the radiating element for the second (upper) patch antenna arrangement will have some impact on the performance of the first (lower) patch antenna arrangement. In practice, a complex RF coupling interaction takes place with antenna 100 to obtain the desired overall performance for both frequency bands of interest.

The illustrated embodiment of antenna 100 includes a ground plane element 102, a first dielectric layer 104 (obscured from view in FIG. 1), a first radiating element 106, a second dielectric layer 108, a second radiating element 110, and a signal feed 112. In certain embodiments, ground plane element 102, first dielectric layer 104, and first radiating element 106 form part of a first antenna arrangement that is fabricated as a first substrate, while second dielectric layer 108 and second radiating element 110 form part of a second antenna arrangement that is fabricated as a second substrate. In this regard, first dielectric layer 104 can be one substrate that is coupled between ground plane element 102 and first radiating element 106, and second dielectric layer 108 can be another substrate coupled to second radiating element 110. Although fabricated as separate components, the two substrates can be coupled together during a subsequent process step (using lamination, bonding, or any suitable technique) such that first radiating element 106 is located between first dielectric layer 104 and second dielectric layer 108 as depicted in FIG. 2.

In practice, the first antenna arrangement may be fabricated by forming thin metal layers on the top and bottom exposed surfaces of dielectric layer 104. The thickness of the metal layers will depend upon the particular dielectric material, the type of metal used, the substrate fabrication technique, and desired performance characteristics. For example, the thickness of the metal layers in practical embodiments may within the range of about 8 to 35 micrometers. Thereafter, the metal layers can be selectively removed or patterned using well known techniques (such as masking, photolithography, and etching) to create the desired size, shape, and features of ground plane element 102, first radiating element 106, and aperture 120 (described below). Likewise, the second antenna arrangement may be fabricated by forming a thin metal layer on the top exposed surface of dielectric layer 108, followed by selective removal of the metal to create the desired size, shape, and features of second radiating element 110. The thickness of the metal layers for the second antenna arrangement will depend upon the particular dielectric material, the type of metal used, the substrate fabrication technique, and desired performance characteristics. For example, the thickness of the metal layers in practical embodiments may be within the range of about 8 to 35 micrometers.

In preferred embodiments, the same dielectric material is used to form both dielectric layers 104/108. In one exemplary embodiment, dielectric layers 104/108 are formed from a ceramic material such as alumina, and the metallization on dielectric layers 104/108 is formed from copper cladding, gold coated copper cladding, using commercial thin film processes, typically specified as 100-150 microinches, or the like. For such an embodiment, the antenna arrangements are suitably configured to cooperate with the dielectric constant (approximately nineteen in this particular embodiment) exhibited by the ceramic dielectric material. In another exemplary embodiment, dielectric layers 104/108 are formed from a dielectric material that is commonly used in printed circuit boards, such as FR-4 or other laminates, and the metallization on dielectric layers 104/108 is formed from copper, aluminum, or the like. The dielectric layers in such an embodiment can be formed from a class of materials including a composite polytetrafluoroethylene (PTFE) with glass or ceramic, and a composite hydrocarbon with ceramic (such as the TMM materials available from Rogers Corp.), with dielectric constants in the range of approximately 2.8 to 10.2. An embodiment that leverages printed circuit board techniques and technologies represents a relatively low cost alternative. For such an embodiment, the antenna arrangements are suitably configured to cooperate with the relatively low dielectric constant (approximately ten or less) exhibited by the laminate dielectric material. Of course, a dual band patch antenna as described herein can be realized using other dielectric materials and metallization materials.

Ground plane element 102 functions as the ground plane for both first radiating element 106 and second radiating element 110. In a typical vehicle installation, ground plane element 102 can be electrically coupled to a conductive sheet or component of the vehicle, such as the roof, a fender, or the trunk lid. In practice, ground plane element 102 may terminate at the boundary of dielectric layer 104 or it may extend beyond the boundary as depicted in FIG. 1 and FIG. 2. In the illustrated embodiment, ground plane element 102 includes a signal port 114 formed therein. Signal port 114 may be realized as a hole or aperture formed in ground plane element 102, and signal port 114 is configured to receive signal feed 112 such that signal feed 112 does not contact ground plane element 102.

Signal port 114 enables the received GPS and SDARS signals to be propagated from dual band patch antenna 100 to the system or systems of interest. In this regard, signal port 114 may include, accommodate, or cooperate with a suitably configured connector 116 for signal feed 112. Connector 116 isolates signal feed 112 from ground plane element 102 using well known principles. Connector 116 may be, for example, a male or female SMA connector or any RF/microwave component. Antenna 100 may also include or be coupled to a system connection cable 118 via connector 116, where system connection cable 118 is configured to propagate signals having frequencies in either of the two bands supported by antenna 100. Notably, antenna 100 utilizes only one connector 116 and only one system connection cable 118 to propagate the dual band signals; this simplifies the installation of antenna 100 and reduces cost.

As shown in FIG. 2, first dielectric layer 104 is located between, and physically separates, ground plane element 102 and first radiating element 106. Similarly, second dielectric layer 108 is located between, and physically separates, first radiating element 106 and second radiating element 110. When deployed, second radiating element 110 will be the upper radiating element of antenna 100, and first radiating element 106 will be the lower radiating element of antenna 100. In this embodiment, first radiating element 106 is sandwiched within the dielectric material, and no portion of first radiating element 106 is exposed. As mentioned above, first dielectric layer 104 and second dielectric layer 108 are preferably formed from a common dielectric material. Notably, although this exemplary embodiment is fabricated by bonding or laminating two patch antenna arrangements together, an alternate embodiment may instead embed or form first radiating element 106 in dielectric material such that the dielectric material contains no seams, junctions, or discontinuities.

Dual band patch antenna 100 utilizes only one signal feed 112, which is shared by both patch antenna arrangements. In other words, signal feed 112 is used for first radiating element 106 and for second radiating element 110. Signal feed 112 may be realized as a solid conductor, a conductive post or wire, a standard sized RF connector pin, or a conductive tube. Notably, signal feed 112 physically contacts only one of the two radiating elements; in the exemplary embodiment signal feed 112 is in electrical contact with second radiating element 110, and signal feed 112 has no direct physical contact with first radiating element 106. Here, signal feed 112 is connected to the lower surface of second radiating element 110, signal feed 112 extends through dielectric layers 104/108, and signal feed 112 extends through signal port 114.

To accommodate signal feed 112, first radiating element 106 includes an aperture 120 formed therein. Aperture 120 may be realized as a hole, a slot, or an opening formed in first radiating element 106, and aperture 120 is configured to receive signal feed 112 such that signal feed 112 does not contact first radiating element 106. During fabrication, a properly sized hole can be drilled through the dielectric material, either stopping at second radiating element 110 or through second radiating element 110. This drilled hole may or may not be plated with metal. Thereafter, signal feed 112 (which may be realized as a standard SMA pin) can be inserted into the hole into contact with second radiating element 110. After installation, signal feed 112 is preferably flush against the dielectric material although a slight gap may exist between the dielectric material and the outer surface of signal feed 112. In practice, signal feed 112 may be soldered or otherwise affixed to second radiating element 110.

Signal feed 112, the dielectric material, and aperture 120 cooperate to function as an aperture coupler for first radiating element 106. In other words, signal feed 112 is coupled to first radiating element 106 via aperture coupling, and absent any physical contact with first radiating element 106 itself. For the illustrated embodiment, the diameter of aperture 120 is influenced by the diameter of signal feed 112, the type of dielectric material, the output impedance of antenna 100, the desired amount of coupling, and the frequencies of the signals to be coupled. Thus, signals received by first radiating element 106 are aperture coupled to signal feed 112, while signals received by second radiating element 110 are directly coupled to signal feed 112. Accordingly, first radiating element 106, the dielectric material, signal feed 112, and ground plane element 102 cooperate to receive signals in the L1 GPS band, while second radiating element 110, the dielectric material, signal feed 112, and ground plane element 102 cooperate to receive signals in the SDARS band.

In practice, the aperture coupling mechanism is arranged to minimize sensitivity to manufacturing and assembly inconsistencies. In particular, large aperture diameters tend to be less sensitive to both the exact feed placement within the aperture and to variations in the dimensions of the feed.

Moreover, antenna 100 lacks any intervening interconnects or shorting pins between ground plane element 102, first radiating element 106, and second radiating element 110. As illustrated in FIG. 2, ground plane element 102 is physically isolated from first radiating element 106 and from second radiating element 110, and first radiating element 106 is physically isolated from second radiating element 110. This relatively simple structure is therefore easy to manufacture and assemble.

The actual size, shape, and arrangement of elements in dual band patch antenna 100 will vary depending upon the particular application, packaging constraints, desired materials, manufacturing considerations, and other practical influences. The embodiment described below with reference to FIG. 1 and FIG. 2 is merely one suitable implementation.

Referring to FIG. 1, both dielectric layers 104/108 are formed from a ceramic material such as alumina, and both dielectric layers 104/108 are approximately 35 mm by 35 mm square. First dielectric layer 104 is 4 mm thick, while second dielectric layer is 3 mm thick. Second radiating element 110 is formed as a 13 mm by 13 mm square with truncated opposing corners as depicted in FIG. 1. The cut corners are utilized to achieve LHCP operation for SDARS frequencies. The dimension 122 for these cut corners is 1.75 mm in this embodiment.

FIG. 1 depicts first radiating element 106 in dashed lines because it is actually hidden from view and sandwiched between the dielectric layers 104/108. First radiating element 106 is formed as a 17 mm by 17 mm square with truncated opposing corners as depicted in FIG. 1. Notably, the truncated corners of first radiating element 106 correspond to the non-truncated corners of second radiating element 110. The cut corners of first radiating element 106 are utilized to achieve RHCP operation for L1 GPS signals. The dimension 124 for these cut corners is 1.75 mm in this embodiment. In this particular embodiment, first radiating element 106 is not centered relative to dielectric layers 104/108. Rather, one side of first radiating element 106 corresponds to one side of second radiating element 110, resulting in an offset positioning of first radiating element 106. In general, first radiating element 106 and second radiating element 110 will not be centered with respect to one another or the dielectric substrates. Rather, their position with respect to the feed placement is chosen in order to achieve a good input impedance match at both frequency bands of interest.

Signal feed 112 may also be offset relative to second radiating element 110. In this regard, the central longitudinal axis of signal feed 112 is positioned about 3.7 mm from the right edges of first radiating element 106 and second radiating element 110. For this embodiment, aperture 120, which is formed in first radiating element 106 and is concentric with signal feed 112, has a radius of approximately 1.7 mm.

Given the physical dimensions of first radiating element 106 and second radiating element 110, the dielectric material for dielectric layers 104/108 is selected to obtain the appropriate center frequencies of operation. Conversely, given the dielectric constants of the materials chosen for dielectric layers 104/108, the physical dimensions could then be selected to obtain the appropriate center frequencies of operation. As mentioned previously, the same dielectric material may, but need not, be chosen for both dielectric layers 104/108. The physical dimensions described above are suitable for ceramic substrates where the dielectric constant for both dielectric layers 104/108 is 19.0. The selection of the same dielectric material is desirable to minimize material costs and to simplify the manufacturing process. This design also uses a particularly wide aperture coupler for the feeding mechanism for first radiating element 106 in an effort to minimize the sensitivity of the structure to feed pin placement. Of course, fine tuning of the various physical parameters (such as the corner truncation dimensions, overall size of the metallization areas, overall size of dielectric layers 104/108, the offset of radiation elements 106/110 relative to signal feed 112, and the dimensions of aperture 120) may be employed to achieve the desired performance for the designated frequency bands.

For the vehicular application described herein, the first patch antenna arrangement is configured to receive signals in a GPS frequency band (e.g., the L1 GPS frequency band of 1.57442 GHz to 1.57642 GHz), while the second patch antenna arrangement is configured to receive signals in the SDARS frequency band (i.e., the 2.320 GHz to 2.345 GHz band). As mentioned previously, the first patch antenna arrangement is suitably configured to receive RHCP signals (such as L1 GPS signals), while the second patch antenna arrangement is suitably configured to receive LHCP signals (such as SDARS signals that originate from satellites). Notably, the second patch antenna arrangement is also configured to effectively receive VLP SDARS signals in the 2.320 GHz to 2.345 GHz frequency band—such signals originate from terrestrial repeaters used by some satellite radio providers. The placement of the SDARS patch antenna arrangement above the GPS patch antenna arrangement results in improved low angle performance for SDARS signals. Moreover, the physical configuration of antenna 100 (e.g., the type and thickness of dielectric material, type and the thickness of the metallization layers) may be designed to increase or reduce the overall height of the SDARS patch antenna, according to the desired gain characteristics for terrestrial VLP SDARS signals.

### Proof Of Concept

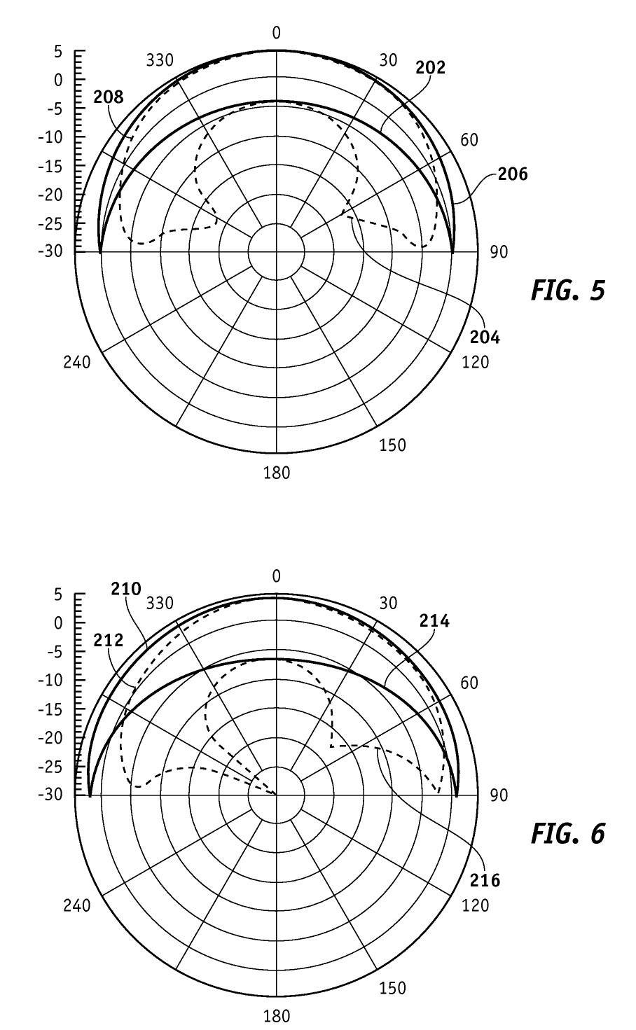

A dual band stacked patch antenna having the dimensions and characteristics described above was validated using an electromagnetic modeling application. The simulations assumed an infinite ground plane. The return loss (S11) is depicted in FIG. 4, which is a graph of the return loss versus frequency for the dual band patch antenna. FIG. 4 shows that the return loss within the two frequency windows near the L1 GPS and SDARS frequency bands is less than −10 dB. FIG. 5 is a diagram of LHCP and RHCP gain patterns for the dual band patch antenna (at a frequency within/near the L1 GPS band), and FIG. 6 is a diagram of LHCP and RHCP gain patterns at a frequency within/near the SDARS band. In FIG. 5, plot 202 represents the LHCP gain pattern at an azimuth angle (θ) of zero degrees, plot 204 represents the LHCP gain pattern at an azimuth angle of ninety degrees, plot 206 represents the RHCP gain pattern at an azimuth angle of zero degrees, and plot 208 represents the RHCP gain pattern at an azimuth angle of ninety degrees. In FIG. 6, plot 210 represents the LHCP gain pattern at an azimuth angle of zero degrees, plot 212 represents the LHCP gain pattern at an azimuth angle of ninety degrees, plot 214 represents the RHCP gain pattern at an azimuth angle of zero degrees, and plot 216 represents the RHCP gain pattern at an azimuth angle of ninety degrees. Within each frequency window, high gain is achieved over a wide elevation angle. Approximately 10 dB of gain suppression of the opposite handed circular polarization at zenith (θ=zero degrees) is achieved within each frequency band. This demonstrates that very little coupling can be achieved between the lower and upper patch antenna arrangements.

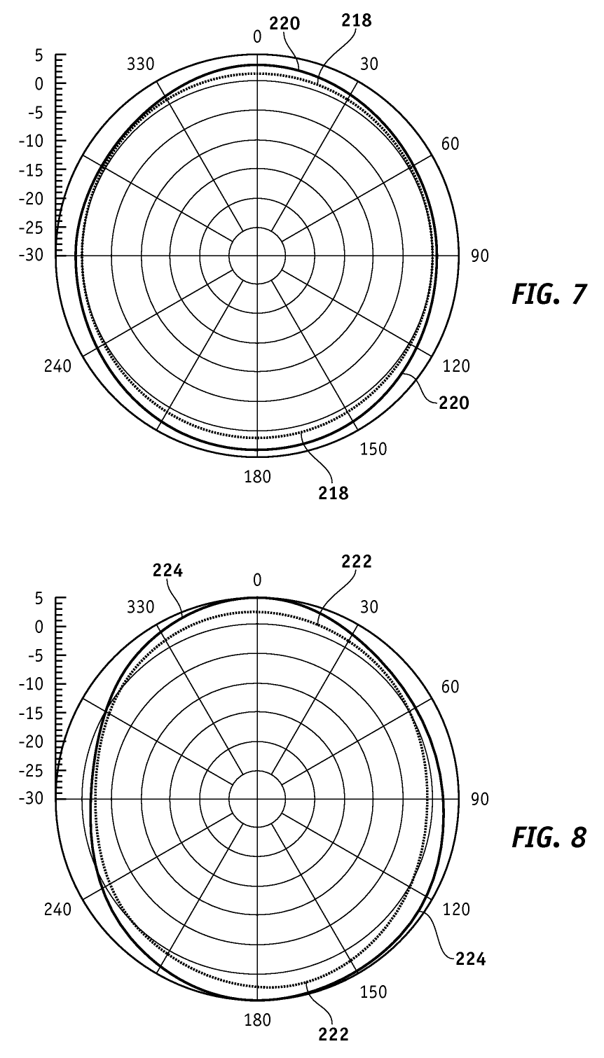

For comparison, FIG. 7 is a diagram of LHCP gain patterns for the dual band patch antenna shown in FIG. 1 and for a currently known standalone SDARS single patch antenna. FIG. 7 compares the LHCP gain patterns of the standalone, single band, SDARS patch antenna (plot 218) and the dual band stacked patch antenna (plot 220) at an elevation angle of sixty degrees down from zenith, i.e., thirty degrees up from horizon. Here it can be seen that in all azimuth directions the stacked patch antenna outperforms the standalone SDARS patch antenna in terms of LHCP gain. FIG. 8 also depicts a comparison of the standalone SDARS antenna versus the dual band stacked patch antenna; FIG. 8 is a diagram of VLP gain patterns for the dual band patch antenna shown in FIG. 1 and for the standalone SDARS single patch antenna at an elevation angle of ninety degrees down from zenith, i.e., at horizon. In FIG. 8, plot 222 represents the VLP gain pattern at horizon for the standalone SDARS patch antenna, while plot 224 represents the VLP gain pattern at horizon for the dual band stacked patch antenna. Again, the dual band stacked patch antenna outperforms the isolated standalone SDARS patch antenna in all directions, providing anywhere from −2.2 dB to more than 5.0 dB of VLP gain. The minimum of −2.2 dB represents a 1.3 dB improvement in the minimum VLP gain at horizon when compared to the isolated standalone SDARS patch antenna. In practice, overall system performance should see an even greater improvement because the VLP gain performance of the standalone SDARS single patch antenna is known to degrade in the presence of other radiating sources, such as a standalone single patch GPS antenna. These results clearly highlight the advantages of the dual GPS/SDARS stacked patch antenna presented herein.

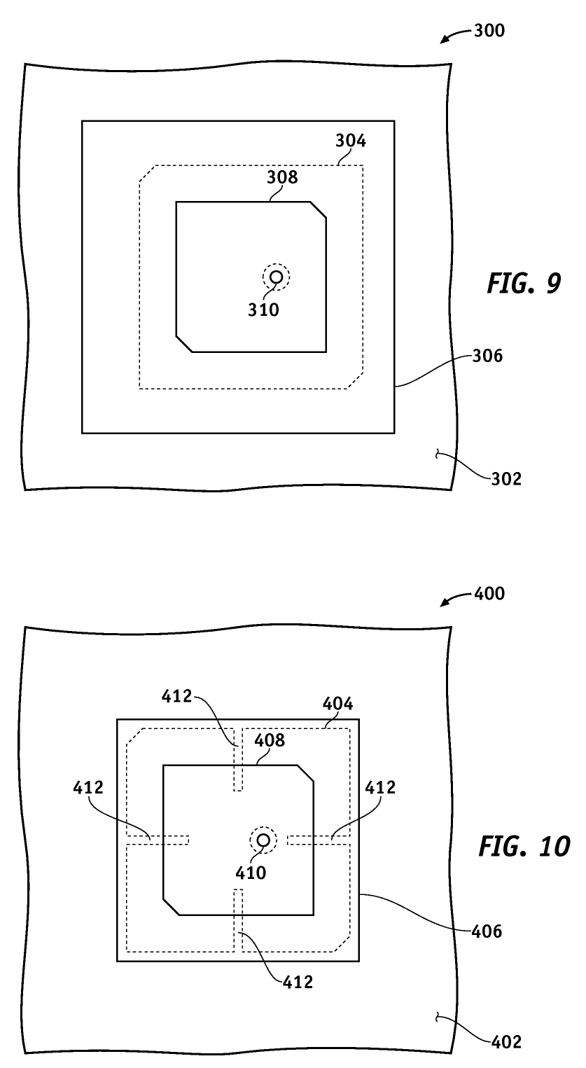

FIG. 9 is a top view of another embodiment of a dual band patch antenna 300. Antenna 300 is similar to antenna 100 in many ways, and common features, elements, and characteristics will not be redundantly described here in the context of antenna 300. Antenna 300 generally includes a ground plane element 302, a first dielectric layer (hidden from view), a first radiating element 304, a second dielectric layer 306, a second radiating element 308, and a signal feed 310.

Antenna 300 employs a circuit board material having a relatively low dielectric constant (about 9.8), for example, TMM10i or alumina. These materials are relatively inexpensive and, therefore, antenna 300 represents a low-cost realization of a dual band stacked patch configuration. The overall dimensions of the first dielectric layer (35 mm by 35 mm, 4 mm thick) and second dielectric layer 306 (35 mm by 35 mm, 3 mm thick) are as described above for antenna 100. First radiating element 304 is formed as a 27 mm by 27 mm square with truncated opposing corners, and second radiating element 308 is formed as a 19 mm by 19 mm square with truncated opposing corners that correspond to the non-truncated corners of first radiating element 304. As mentioned above in connection with antenna 100, both radiating elements 304/308 are offset (off-axis) from signal feed 310. In contrast to antenna 100, first radiating element 304 does not “share” a side with second radiating element 308. As depicted in FIG. 9, the outer boundary of second radiating element 308 as projected onto first radiating element 304 resides within the outer boundary of first radiating element 304. In other words, from the perspective of FIG. 9, the outline of second radiating element 308 completely fits within the outline of first radiating element 304. Simulations of antenna 300 show that it provides more than a 3 dB improvement in the minimum VLP gain when compared to a conventional standalone SDARS patch antenna.

FIG. 10 is a top view of yet another embodiment of a dual band patch antenna 400. Antenna 400 is similar to antenna 100 in many ways, and common features, elements, and characteristics will not be redundantly described here in the context of antenna 400. Antenna 400 generally includes a ground plane element 402, a first dielectric layer (hidden from view), a first radiating element 404, a second dielectric layer 406, a second radiating element 408, and a signal feed 410.

Antenna 400 employs a circuit board material having an even lower dielectric constant (about 6.0), for example, TMM6 or other Duroid materials. The overall dimensions of the first dielectric layer (35 mm by 35 mm, 4 mm thick) and second dielectric layer 306 (35 mm by 35 mm, 3 mm thick) are as described above for antenna 100. First radiating element 404 is generally formed as a 33 mm by 33 mm square with truncated opposing corners. Notably, first radiating element 404 incorporates slits 412 in order to make the overall package more compact while benefiting from the very low dielectric constant (without slits 412, the dimensions of first radiating element 404 would extend beyond the 35 mm by 35 mm form factor boundary). Here, each slit 412 extends 9.0 mm inward from the outside edge of first radiating element 404, and each slit 412 is 1.0 mm wide. Moreover, a portion of each slit 412 extends beneath second radiating element 408 (as shown in the projected view of FIG. 10). As shown in FIG. 10, each slit 412 extends perpendicularly from the respective edge of first radiating element 404, and each slit 412 is centrally located along the respective edge. In operation, although current exists along the edges of first radiating element 404 (including along the edges of slits 412 that extend beneath second radiating element 408), essentially all of the electromagnetic energy is still radiated along the outer edges of first radiating element 404 that reside beyond the physical dimensions of second radiating element 408, which is located above first radiating element 404. Thus, minimal interference takes place between the radiating elements 404/408.

Second radiating element 408 is formed as a 23 mm by 23 mm square with truncated opposing corners that correspond to the non-truncated corners of first radiating element 404. As depicted in FIG. 10, the outer boundary of second radiating element 408 as projected onto first radiating element 404 resides within the overall outer boundary of first radiating element 404. In other words, from the perspective of FIG. 10, the footprint of second radiating element 408 completely fits within the outer 33 mm by 33 mm footprint of first radiating element 404. As mentioned above in connection with antenna 100, both radiating elements 404/408 are offset (off-axis) from signal feed 410. In contrast to antenna 100, first radiating element 404 does not “share” a side with second radiating element 408. In an alternate embodiment of antenna 400, second radiating element 408 may include slits as described above for first radiating element 404, thus resulting in a smaller patch footprint. Moreover, either or both radiating elements 404/408 could employ alternate compact design methodologies that are currently known, or those that might be developed in the future.

To summarize, embodiments of a dual band stacked patch antenna described herein are capable of simultaneously receiving both RHCP satellite signals within the L1 GPS frequency band and LHCP satellite signals within the SDARS frequency band. In addition, embodiments of the antenna described herein provide improved SDARS vertical linear polarization gain for terrestrial signal reception at low elevation angles as compared to current state of the art SDARS patch antennas. This improved VLP gain is achieved in part by placing an SDARS patch antenna element above a GPS patch antenna element, thereby raising the SDARS radiating element further above the ground plane, relative to conventional standalone SDARS patch antennas. Moreover, the compact, low profile, stacked patch design of the antenna reduces the overall size of the antenna module, which in turn decreases the rooftop surface area required to mount the antenna on a vehicle. Furthermore, the antenna employs a single feed that is utilized to propagate signals in both the GPS band and the SDARS band. This single feed approach reduces design complexity, manufacturing costs, cabling costs, and assembly time.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A dual band patch antenna comprising:
a first patch antenna arrangement configured to receive signals in a first frequency band;
a second patch antenna arrangement coupled to, and stacked on, the first patch antenna arrangement, the second patch antenna arrangement being configured to receive signals in a second frequency band; and
only one signal feed shared by both the first patch antenna arrangement and the second patch antenna arrangement.

2. The dual band patch antenna of claim 1, wherein:
the first patch antenna arrangement is configured to receive signals in a global positioning system (GPS) frequency band; and
the second patch antenna arrangement is configured to receive signals in a satellite digital audio radio service (SDARS) frequency band.

3. The dual band patch antenna of claim 2, wherein:
the first patch antenna arrangement is configured to receive right hand circularly polarized L1 GPS signals in the 1.57422 GHz to 1.5762 GHz frequency band; and
the second patch antenna arrangement is configured to receive left hand circularly polarized SDARS signals in the 2.320 GHz to 2.345 GHz frequency band.

4. The dual band patch antenna of claim 3, wherein the second patch antenna arrangement is configured to receive vertical linear polarized SDARS signals in the 2.320 GHz to 2.345 GHz frequency band.

5. The dual band patch antenna of claim 1, wherein the first frequency band and the second frequency band are non-overlapping.

6. The dual band patch antenna of claim 1, wherein:
the first patch antenna arrangement comprises a first radiating element;
the second patch antenna arrangement comprises a second radiating element and a second dielectric layer that separates the second radiating element from the first radiating element;
the signal feed is connected to the second radiating element; and
the signal feed is coupled to the first radiating element via aperture coupling and absent physical contact with the first radiating element.

7. The dual band patch antenna of claim 6, further comprising:
a first dielectric layer of the first patch antenna arrangement; and
a ground plane element, the first dielectric layer separating the first radiating element from the ground plane element.

8. The dual band patch antenna of claim 7, further comprising a signal port formed in the ground plane element, the signal port being configured to receive the signal feed.

9. The dual band patch antenna of claim 7, wherein the first dielectric layer and the second dielectric layer are formed from a common dielectric material.

10. A dual band patch antenna comprising:
a first antenna arrangement comprising a ground plane element, a first radiating element, and a first dielectric layer coupled between the ground plane element and the first radiating element;
a second antenna arrangement coupled to the first antenna arrangement, the second antenna arrangement comprising a second radiating element and a second dielectric layer coupled to the second radiating element, and the second antenna arrangement being coupled to the first antenna arrangement such that the first radiating element is located between the first dielectric layer and the second dielectric layer; and
a signal feed shared by both the first antenna arrangement and the second antenna arrangement.

11. The dual band patch antenna of claim 10, wherein:
the first antenna arrangement is formed from a first printed circuit board; and
the second antenna arrangement is formed from a second printed circuit board.

12. The dual band patch antenna of claim 10, wherein:
the first antenna arrangement is formed from a first ceramic material having a high dielectric constant; and
the second antenna arrangement is formed from a second ceramic material having a high dielectric constant.

13. The dual band patch antenna of claim 10, wherein the signal feed physically contacts only one of the first radiating element or the second radiating element.

14. The dual band patch antenna of claim 13, wherein:
the signal feed physically contacts the second radiating element; and
the signal feed is coupled to the first radiating element via aperture coupling.

15. The dual band patch antenna of claim 10, wherein the first radiating element includes a number of slits formed therein, and wherein a portion of each of the slits extends beneath the second radiating element.

16. The dual band patch antenna of claim 10, wherein:
the first radiating element cooperates with the signal feed and the ground plane element to receive signals in a first frequency band; and
the second radiating element cooperates with the signal feed and the ground plane element to receive signals in a second frequency band.

17. A dual band patch antenna comprising:
a ground plane element having a signal port formed therein;
an upper radiating element;
dielectric material between the ground plane element and the upper radiating element;
a lower radiating element located within the dielectric material, the lower radiating element comprising an aperture formed therein; and
only one signal feed for both the upper radiating element and the lower radiating element, the signal feed being connected to the upper radiating element, and the signal feed extending through the dielectric material, through the aperture without contacting the lower radiating element, and through the signal port without contacting the ground plane element; wherein
the lower radiating element, the dielectric material, the signal feed, and the ground plane element cooperate to receive signals in a first frequency band; and
the upper radiating element, the dielectric material, the signal feed, and the ground plane element cooperate to receive signals in a second frequency band.

18. The dual band patch antenna of claim 17, wherein:
the lower radiating element, the dielectric material, the signal feed, and the ground plane element are configured to receive right hand circularly polarized L1 global positioning system (GPS) signals in the 1.57422 GHz to 1.5762 GHz frequency band; and
the upper radiating element, the dielectric material, and the ground plane element are configured to receive left hand circularly polarized satellite digital audio radio service (SDARS) signals and vertical linear polarized SDARS signals in the 2.320 GHz to 2.345 GHz frequency band.

19. The dual band patch antenna of claim 17, wherein the signal feed is coupled to the lower radiating element via aperture coupling.

20. The dual band patch antenna of claim 17, further comprising:
a connector for the signal feed; and
only one system connection cable coupled to the connector, the system connection cable being configured to propagate signals in the first frequency band and signals in the second frequency band.
